(19) United States
(12) Patent Application Publication
(10) Pub. No.: US 2014/0035471 A1
(43) Pub. Date: Feb. 6, 2014

(54) CURRENT DISTRIBUTOR

(71) Applicants: Yung-Hsin Chiang, New Taipei City (TW); Yi-Mei Li, New Taipei City (TW)

(72) Inventors: Yung-Hsin Chiang, New Taipei City (TW); Yi-Mei Li, New Taipei City (TW)

(21) Appl. No.: 13/596,073

(22) Filed: Aug. 28, 2012

(30) Foreign Application Priority Data
Aug. 1, 2012 (TW) 101127740

(51) Int. Cl. H05B 37/00

(52) U.S. Cl. 315/185 R

(57) ABSTRACT

A current distributor includes a plurality of current adjustment units and a reference voltage adjustment unit. The plurality of current adjustment units is for distributing currents flowing through plural sets of light emitting diodes. The reference voltage adjustment unit is coupled to the plurality of current adjustment units for controlling the plurality of current adjustment units according to a reference voltage.

### BACKGROUND OF THE INVENTION

1. Field of the Invention

The present invention is related to a current distributor, and more particularly to a current distributor used in a light emitting diode backlight system.

2. Description of the Prior Art

With the advancement of light emitting diode (LED) backlight systems, more and more flat display panels are using LED backlight system as the source for backlight. Various types of sets of serially connected LEDs are required by different sizes and types of flat display panels.

Due to deviation in electrical characteristics of each LED, when LEDs are connected in series to form plural sets of LEDs, each set of LEDs may suffer from current imbalance, that is, current flowing through each set of LEDs may differ and thereby cause uneven distributions of backlight of flat display panels and deteriorate display quality.

Furthermore, disposing a power supply and a current source of the LED backlight system on a same mainboard so as to reduce thickness of a flat display panel requires many connection lines for controlling plural sets of LEDs, which is not only more complicated to produce but also more susceptible to noise.

### SUMMARY OF THE INVENTION

An embodiment of the present invention discloses a light emitting diode backlight system. The system comprises a mainboard, a power supply, a current source, a backlight module, a first power line, and a second power line. The backlight module comprises plural sets of LEDs, a plurality of current adjustment units, and a reference voltage adjustment unit. The power supply and the current source are disposed on the mainboard. The current source is coupled to the power supply. The plurality of current adjustment units are coupled to the plural sets of LEDs for distributing currents flowing through the plural sets of LEDs. The reference voltage adjustment unit is coupled to the plurality of current adjustment units for controlling the plurality of current adjustment units according to a reference voltage. The first power line is coupled between the power supply and the plural sets of LEDs for supplying a high voltage to the plural sets of LEDs. The second power line is coupled between the current source and the plurality of current adjustment units for transmitting current outputted from the plurality of current adjustment units to the current source.

Another embodiment of the present invention discloses a current distributor. The current distributor comprises a plurality of current adjustment units, and a reference voltage adjustment unit. The reference voltage adjustment unit comprises a first amplifier, a first resistor, a second resistor, a first diode, and a reference voltage source. The plurality of current adjustment units are for distributing currents flowing through plural sets of LEDs. The reference voltage source is coupled to the plurality of current adjustment units for controlling the plurality of current adjustment units according to a reference voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a light emitting diode backlight system according to an embodiment of the present invention.

FIG. 2 is a diagram illustrating the current distributor of FIG. 1 according to an embodiment of the present invention.

FIG. 3 is a diagram illustrating the current distributor of FIG. 1 according to another embodiment of the present invention.

FIG. 4 is a diagram illustrating operation of the current distributor of FIG. 3 utilized in the backlight module of FIG. 1 when one set of LEDs is open circuited.

### DETAILED DESCRIPTION

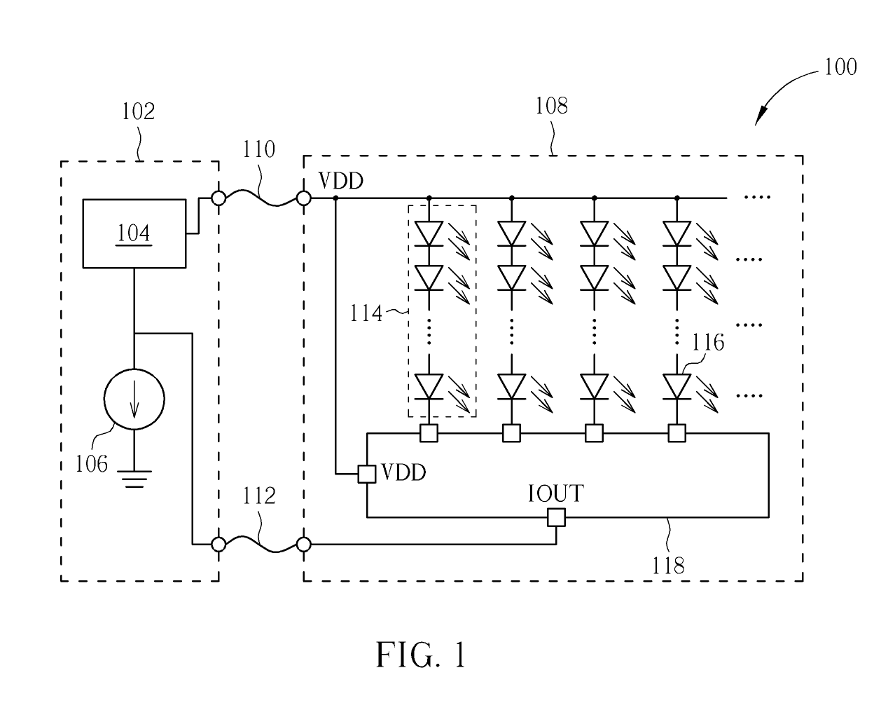

Please refer to FIG. 1 that is a diagram illustrating a light emitting diode (LED) backlight system 100 according to an embodiment of the present invention. The LED backlight system 100 may include a main board 102, a power supply 104, a current source 106, a backlight module 108, a first power line 110 and a second power line 112. The power supply 104 and the current source 106 are disposed in the main board 102 and the current source 106 is coupled to the power supply 104. The backlight module 108 may include plural sets of LEDs 114 and a current distributor 118. Each set of LEDs 114 includes a plurality of serial connected LEDs 116. The current distributor 118 is coupled to the plural sets of LEDs 114 for distributing currents flowing through the plural sets of LEDs 114. The first power line 110 is coupled between the power supply 104 and the plural sets of LEDs 114 for supplying a high voltage VDD from the power supply 104 to the plural sets of LEDs 114. The second power line 112 is coupled between the current source 106 and an end IOUT of the current distributor 118 for transmitting current outputted from the end IOUT to the current source 106.

In an embodiment, the mainboard 102, the power supply 104 and the current source 106 of FIG. 1 may be disposed in a housing, whereas the backlight module 108 may be disposed in a case other than the housing. A connection device may be used to connect the housing and the case, thereby allowing change of relative positions between the housing and the case. In another embodiment, the mainboard 102, the power supply 104, the current source 106, the backlight module 108, the first power line 110, and the second power line 112 may be disposed in a housing.

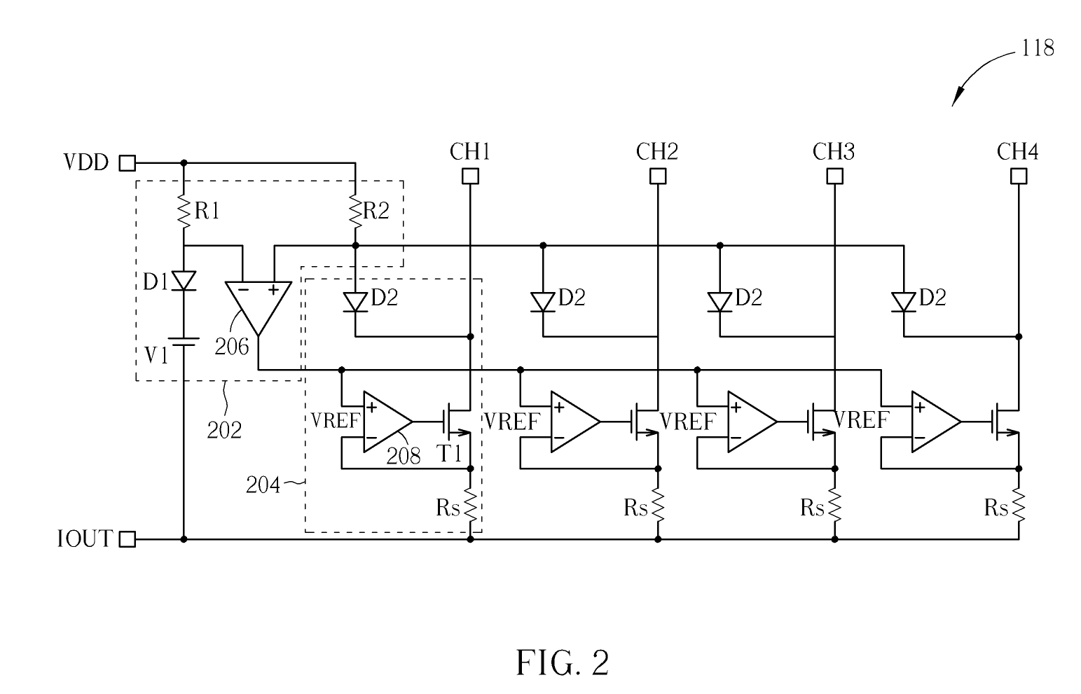

Please refer to FIG. 2 that is a diagram illustrating the current distributor 118 of FIG. 1 according to an embodiment of the present invention. The current distributor 118 may include a reference voltage adjustment unit 202 and a plurality of current adjustment units 204. The reference voltage adjustment unit 202 is coupled to the plurality of current adjustment units 204 for controlling the plurality of current adjustment units 204 according to a reference voltage V1. The plurality of current adjustment units 204 is coupled to the plural sets of LEDs 114 for distributing currents flowing through the plural sets of LEDs 114.

The reference voltage adjustment unit 202 may include a first amplifier 206, a first resistor R1, a second resistor R2, a first diode D1, and a reference voltage source V1. The first amplifier 206 has a positive input, a negative input and an output. The first resistor R1 has a first end for receiving the high voltage VDD and a second end coupled to the negative input of the first amplifier 206. The second resistor R2 has a first end for receiving the high voltage VDD and a second end coupled to the positive input of the first amplifier 206. The first diode D1 has an anode and a cathode, the anode of the first diode D1 being coupled to the negative input of the first amplifier 206. The reference voltage source V1 has a positive end coupled to the cathode of the first diode D1 and a negative end for receiving a low voltage VSS on the end IOUT, and the reference voltage source V1 is for providing the reference voltage V1. The low voltage VSS is assumed to be 0V for all embodiments of the present invention.

Each current adjustment unit 204 of the plurality of current adjustment units 204 may include a second amplifier 208, a transistor T1, a third resistor Rs, and a second diode D2. The second amplifier 208 has a positive input coupled to the output of the first amplifier 206, a negative input, and an output. The transistor T1 has a control end coupled to the output of the second amplifier 208, a first end coupled to the negative input of the second amplifier 208, and a second end coupled to a corresponding set of LEDs 114 of the plural sets of LEDs 114. The third resistor Rs is coupled between the first end of the transistor T1 and the negative end of the reference voltage source V1. The second diode has an anode coupled to the positive input of the first amplifier 206 and a cathode coupled to the second end of the transistor T1. The transistor T1 may be an N-type MOSFET (metal-oxide-semiconductor field-effect transistor). The control end, the first end, and the second end of the transistor T1 may respectively be a gate, a source, and a drain of MOSFET.

Operations of the current distributor 118 distributing current flowing through the plural sets of LEDs 114 of FIG. 2 is explained below. Please refer to FIG. 1 and FIG. 2 together. For brevity, four sets of current adjustment units 204 and four sets of LEDs 114 are shown in FIG. 1 and FIG. 2 as example but the present invention is not limited thereto, any number of sets of current adjustment units 204 and LEDs 114 are in the scope of the present invention. Four sets of current adjustment units 204 in FIG. 2 are respectively coupled to an end CH1, an end CH2, an end CH3, and an end CH4. The end CH1, the end CH2, the end Ch3, and the end CH4 are respectively coupled to a corresponding set of LEDs 114 of four sets of LEDs 114. Forward conduction voltage VF of the second diode D2 in each current adjustment unit 204 may be substantially equal to the first diode D1. Values of the third resistors Rs of current adjustment units 204 may be substantially equal. Each set of LEDs includes the plurality of serial connected LEDs 116 and forward voltage of each LED 116 increases as current flowing through each LED 116 increases. If current flowing through the set of LEDs 114 coupled between the first power line 110 and the end CH1 is higher than that flowing through other sets of LEDs 114 coupled to the end CH2, the end CH3, and the end CH4, voltage drop VD across the set of LEDs 114 coupled between the first power line 110 and the end CH1 will be higher than voltage drop across other sets of LEDs 114, causing voltage drop (VDD-VD) across the current adjustment unit 204 coupled between the end CH1 and the end IOUT to be lower than voltage drop across other current adjustment units 204. Since the anodes of the second diodes D2 of four current adjustment units 204 are coupled to a same node, the second diode D2 of the current adjustment unit 204 coupled to the end CH1 conducts and clamps voltage on the anodes of four second diodes D2, preventing forward voltage of other second diodes D2 from being high enough to conduct. For example, assuming forward conduction voltage VF of four second diodes D2 and that of four first diodes D1 are 0.6V, voltage drop (VDD-VD) across the current adjustment unit 204 coupled between the end CH1 and the end IOUT is 0.2V, and voltage drop across other current adjustment units 204 respectively coupled to the end CH2, the end CH3, and the end CH4 are all 0.3V, thus voltage on the anodes of four second diodes D2, which is 0.2V+0.6V=0.8V, are determined by the current adjustment unit 204 coupled to the end CH1, and thereby preventing other second diodes D2 from conducting because forward voltage of other second diodes D2 are smaller than forward conduction voltage VF (0.6V). For example, the second diode D2 of the current adjustment unit 204 coupled to the end CH2 will not conduct because forward voltage of that second diode D2 is 0.8V−0.3V=0.5V, which is smaller than forward conduction voltage VF of the said second diode D2.

Voltage on the positive input of the first amplifier 206, 0.8V, is also determined by the current adjustment unit 204 coupled to the end CH1. If the reference voltage V1 is 0.4V, voltage on the negative input of the first amplifier 206 will be 0.4V+VF (0.6V)=1V, which is higher than voltage on the positive input of the first amplifier 206. Thus voltage VREF on the output of the first amplifier 206 and on the positive inputs of the second amplifiers 208 of four current adjustment units 204 decreases, and voltages on the outputs of the second amplifiers 208 of the four current adjustment units 204 decrease accordingly. Then voltages Vgs across the gates and the sources of the transistors T1 of the four current adjustment units 204 decrease. Ideally, currents flowing through the transistors T1 of the four current adjustment units 204 decrease as Vgs decrease and the said currents should not be affected by voltage differences between the drains and the sources of the transistors T1 because the transistors T1 of the present invention operate in saturation region. Thus currents flowing through the four sets of LEDs 114 and the third resistors Rs of the four current adjustment units 204 corresponding thereto decrease. Voltage drop VD across the set of LEDs 114 coupled between the first power line 110 and the end CH1 decreases as current flowing through that set of LEDs 114 decreases, causing voltage drop (VDD-VD) across the end CH1 and the end IOUT to increase. Since the first amplifier 206 is configured to utilize negative feedback control, (VDD-VD) on the positive input of the first amplifier 206 will increase to approximately 1V as voltage on the negative input of the first amplifier 206. Thus voltages on the anodes of the second diodes D2 of the four current adjustment units 204 will also increase to approximately 1V and voltage drop (VDD-VD) across the current adjustment unit 204 coupled between the end CH1 and the end IOUT will increase to approximately the reference voltage V1 (0.4V). Therefore, voltage drop (VDD-VD) may dynamically be maintained around the reference voltage V1. Further, since the second amplifier 208 of each current adjustment unit 204 is configured to utilize negative feedback control, voltage on the negative input varies with VREF on the positive input of each second amplifier 208 and dynamically follows VREF. Thus current flowing through each set of LEDs 114 is dynamically maintained at

$$\frac{VREF - VSS}{Rs} ,$$

achieving even distribution of currents flowing through the plural sets of LEDs 114. In this embodiment, the current adjustment unit 204 having a minimum voltage drop across the drain of the transistor T1 and the end IOUT is used as a benchmark to dynamically adjust VREF according to the reference voltage V1, and then to dynamically adjust other current adjustment units 204 according to VREF so as to evenly distribute currents flowing through the plural sets of LEDs 114.

In another embodiment, when voltage on the negative input of the first amplifier 206 is lower than that on the positive input of the first amplifier 206, voltage on the positive input of the first amplifier 206 is dynamically adjusted to follow voltage on the negative input of the first amplifier 206, and voltage on the negative input varies with VREF on the positive input of each second amplifier 208 and dynamically follows VREF because the first amplifier 206 and each second amplifier 208 are configured to utilize negative feedback control. Thus the current distributor of FIG. 2 may evenly distribute current flowing through the plural sets of LEDs 114 and dynamically maintain the said current level at

$$\frac{VREF - VSS}{Rs} .$$

This embodiment applies the same operation principles as previous embodiment.

In practice, due to channel effect of the transistors T1, when the transistors T1 operate in saturation region, currents flowing from the drains to the sources of the transistors T1 may increase as voltage differences between the drains and the sources of the transistors T1 increase, which causes currents flowing through the plural sets of LEDs 114 to differ from each other. The embodiment of the present invention of FIG. 2 not only can evenly distribute currents flowing through the plural sets of LEDs 114 but also can eliminate current imbalance caused by channel effect. Since VREF on the positive input of the second amplifiers 208 are coupled to a same node and the second amplifiers 208 of the current adjustment units 204 utilize negative feedback control, voltages on the negative inputs of the second amplifiers 208 will be dynamically adjusted to approximately VREF as voltages on the positive inputs of the second amplifiers 208. Thus current flowing through each set of LEDs 114 is approximately

$$\frac{VREF - VSS}{Rs}$$

regardless of voltage differences between the drains and the sources of the transistors T1 and thereby eliminating current imbalance caused by channel effect.

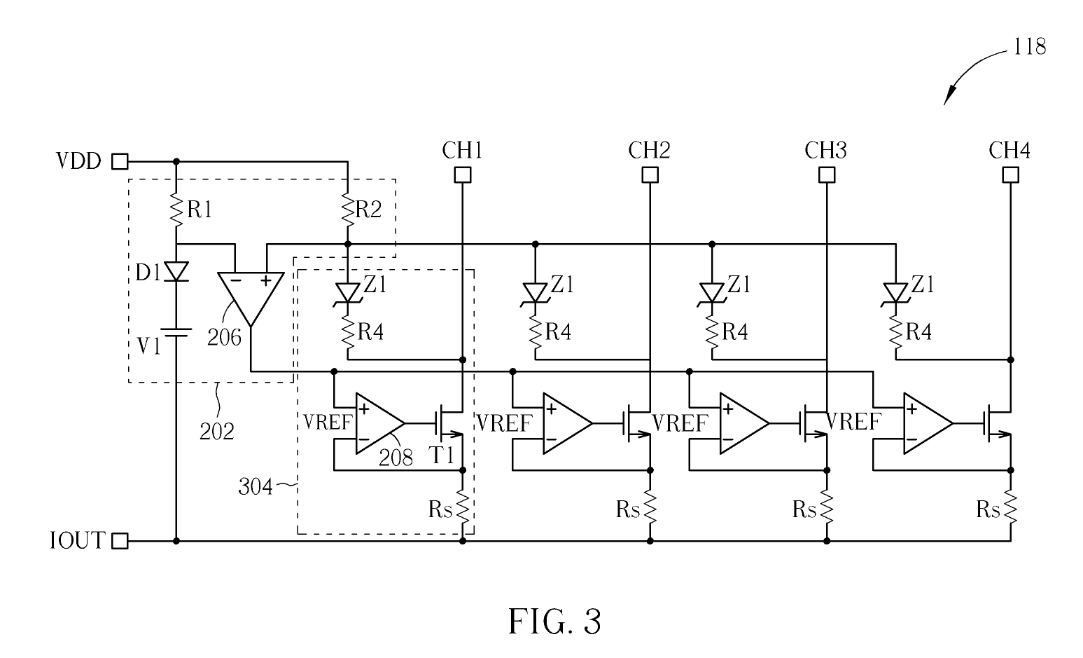

Please refer to FIG. 3 that is a diagram illustrating the current distributor 118 of FIG. 1 according to another embodiment of the present invention. The current distributor 118 may include the reference voltage adjustment unit 202 and a plurality of current adjustment units 304. The reference voltage adjustment unit 202 is coupled to the plurality of current adjustment units 304 for controlling the plurality of current adjustment units 304 according to the reference voltage V1. The plurality of current adjustment units 304 is for distributing currents flowing through the plural sets of LEDs 114. The reference voltage adjustment unit 202 of FIG. 3 is the same as that of FIG. 2.

Each current adjustment unit 304 includes the second amplifier 208, the transistor T1, the third resistor Rs, a fourth resistor R4, and a zener diode Z1. The second amplifier 208, the transistor T1, and the third resistor Rs are the same as that of FIG. 2. The zener diode Z1 has an anode and a cathode, the anode of the zener diode Z1 being coupled to the positive input of the first amplifier 206. The fourth resistor R4 is coupled between the cathode of the zener diode Z1 and the second end of the transistor T1 for limiting current flowing through the zener diode Z1. The transistor T1 may be an N-type MOSFET and operates in saturation region.

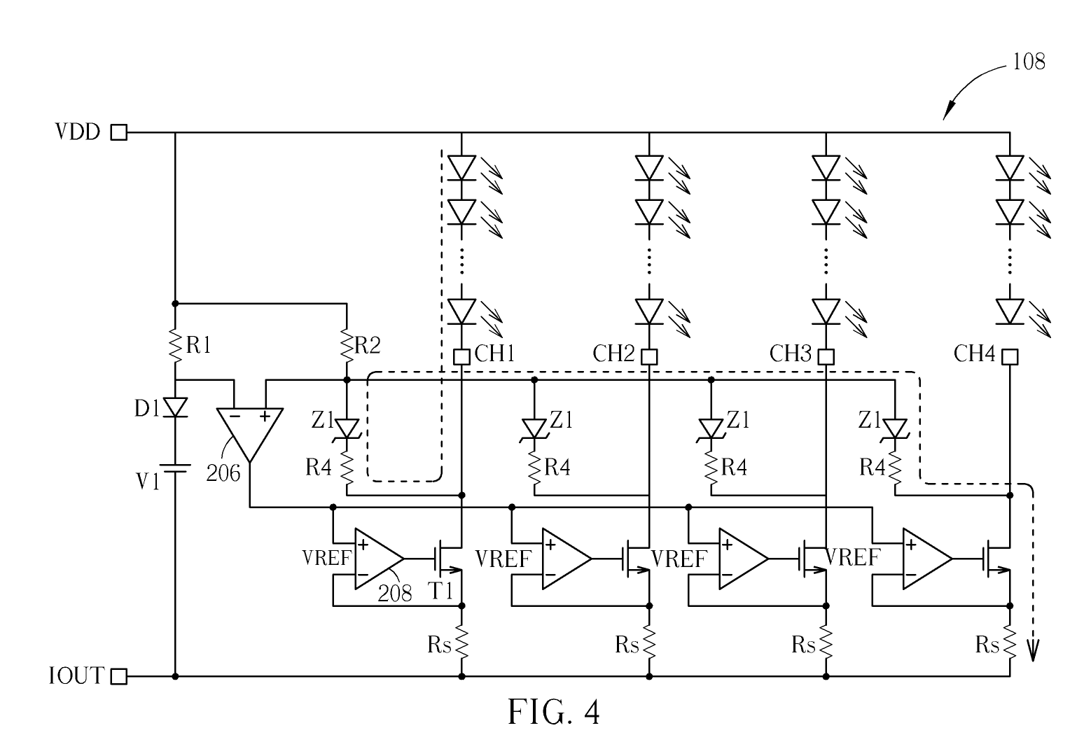

Please refer to FIG. 1 and FIG. 3. For brevity, four sets of current adjustment units 204 and four sets of LEDs 114 are shown in FIG. 1, FIG. 3, and FIG. 4 as example but the present invention is not limited thereto, any number of sets of current adjustment units 204 and LEDs 114 are in the scope of the present invention. The current adjustment units 304 apply the same principles as FIG. 2 in normal operation except that the second diode D2 is replaced by the serial connected fourth resistor R4 and zener diode Z1. Forward conduction voltage VF of the first diode D1 may be substantially equal to forward conduction voltage VF1 of the zener diode Z1 plus voltage drop across the fourth resistor R4 in this embodiment.

Please refer to FIG. 1, FIG. 3 and FIG. 4. FIG. 4 is a diagram illustrating operation of the current distributor 118 of FIG. 3 utilized in the backlight module of FIG. 1 when one set of LEDs 114 is open circuited. When the set of LEDs 114 coupled to the end CH4 is open circuited and causes abnormal condition, current stops flowing through the transistor T1 and the third resistor Rs of the current adjustment unit 304 coupled to the end CH4, so voltage drop across the end CH4 and the end IOUT is about VSS (0V), which is lower than voltage drop across other current adjustment units 304 coupled between the end CH1 and the end IOUT, the end CH2 and the end IOUT, the end CH3 and the end IOUT. Thus voltage on positive input of the first amplifier 206 is approximately equal to forward conduction voltage VF1 of the zener diode Z1 and is determined by the current adjustment unit 304 coupled to the end CH4. Voltage on the negative input of the first amplifier 206 is 1V and is higher than voltage on the positive input of the first amplifier 206. Thus voltage VREF on the output of the first amplifier 206 and the positive inputs of the second amplifiers of the four current adjustment units 304 will decrease. VREF decreases greatly as voltage on the positive input becomes much lower than that on the negative input of the first amplifier 206. So voltages on the outputs of the second amplifiers 208 of the four current adjustment units 304 also decrease greatly. Then voltages Vgs across the gates and the sources of the transistors T1 of the four current adjustment units 304 decrease and currents flowing through sets of LEDs coupled to the end CH1, the end CH2, the end CH3 and the third resistors Rs corresponding thereto also decrease greatly. Thus voltage drop across the end CH1 and the end IOUT, the end CH2 and the end IOUT, the end CH3 and the end IOUT increases greatly. When the highest voltage drop among voltage drop across the end CH1 and the end IOUT, the end CH2 and the end IOUT, the end CH3 and the end IOUT is higher than reverse conduction voltage VR of the zener diode Z1 of the current adjustment unit 304 having the highest voltage drop plus forward conduction voltage VF1 of the zener diode Z1 of the current adjustment unit 304 coupled to the end CH4, neglecting voltage drop across the fourth resistor R4, the zener diode Z1 of the current adjustment unit 304 with the highest voltage drop conducts. Assuming voltage drop across the end CH1 and the end IOUT of the current adjustment unit 304 coupled to the end CH1 is the highest and the zener diode Z1 of the said current adjustment unit 304 conducts in this embodiment, a path for current to flow is then formed as indicated by a dash line of FIG. 4. Current may flow through the path from the first power line 110 (having the high voltage VDD) to the set of LEDs 114 coupled to the end CH1, to the fourth resistor R4 and the zener diode Z1 of the current adjustment unit 304 coupled to the end CH1, to the zener Z1, the fourth resistor R4, the transistor T1, and the third resistor R3 of the current adjustment unit 304 coupled to the open circuited end CH4, then to the end IOUT, thereby increasing voltage drop across the current adjustment unit 304 coupled between the open circuited end CH4 and the end IOUT to be higher than VSS (0V). Thus voltage difference between the positive input and the negative input of the first amplifier 206 may be maintained within a dynamically adjustable range for negative feedback control, thereby preventing voltage difference between the positive input and the negative input of the first amplifier 206 from exceeding the dynamically adjustable range when one of the sets of LEDs 114 is open circuited. In this case, other sets of current adjustment units 304 coupled to the end CH1, the end CH2, and the end CH3 may still distribute currents flowing through corresponding sets of LEDs 114 evenly so that current flowing through the sets of LEDs 114 coupled to the end CH1, the end CH2, and the end CH3 may respectively be maintained at

$$\frac{VREF - VSS}{Rs} .$$

In summary, the current distributor of the present invention can evenly distribute currents flowing through each set of LEDs among the plural sets of LEDs and eliminate current imbalance caused by channel effect of transistors. When one set of LEDs is open circuited, the current distributor according to an embodiment of the present invention can automatically distribute currents evenly among other sets of LEDs so as to prevent current imbalance under abnormal condition such as open circuited. Further, by utilizing the circuit structure of the present invention, only two lines, the first power line and the second power line, are required to connect the mainboard and the backlight module for controlling the backlight module by the mainboard without the need to implement extra signal lines in order to reduce unwanted interference.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light emitting diode (LED) backlight system comprising:
a mainboard;
a power supply disposed on the mainboard for supplying power;
a current source disposed on the mainboard and coupled to the power supply;
a backlight module comprising:
plural sets of LEDs, each set of LEDs comprising a plurality of serial connected LEDs;
a plurality of current adjustment units coupled to the plural sets of LEDs for distributing currents flowing through the plural sets of LEDs; and
a reference voltage adjustment unit coupled to the plurality of current adjustment units for controlling the plurality of current adjustment units according to a reference voltage;
a first power line coupled between the power supply and the plural sets of LEDs for supplying a high voltage to the plural sets of LEDs; and
a second power line coupled between the current source and the plurality of current adjustment units for transmitting current outputted from the plurality of current adjustment units to the current source.

2. The LED backlight system of claim 1 further comprising:
a housing wherein the mainboard, the power supply, and the current source are disposed in the housing;
a case wherein the backlight module is disposed in the case; and
a connection device for connecting the housing and the case, thereby allowing change of relative positions between the housing and the case.

3. The LED backlight system of claim 1 further comprising:
a housing wherein the mainboard, the power supply, the current source, the backlight module, the first power line, and the second power line are disposed in the housing.

4. The LED backlight system of claim 1 wherein the reference voltage adjustment unit comprises:
a first amplifier having a positive input, a negative input, and an output;
a first resistor coupled between the first power line and the negative input of the first amplifier;
a second resistor coupled between the first power line and the positive input of the first amplifier;
a first diode having an anode and a cathode, the anode of the first diode being coupled to the negative input of the first amplifier; and
a reference voltage source coupled between the cathode of the first diode and the second power line for providing the reference voltage.

5. The LED backlight system of claim 4 wherein each current adjustment unit comprises:
a second amplifier having a positive input coupled to the output of the first amplifier, a negative input, and an output;
a transistor having a control end coupled to the output of the second amplifier, a first end coupled to the negative input of the second amplifier and a second end coupled to a corresponding set of LEDs; and
a third resistor coupled between the second power line and the first end of the transistor.

6. The LED backlight system of claim 5 wherein the transistor is an N-type MOSFET (metal-oxide-semiconductor field-effect transistor) and operates in saturation region.

7. The LED backlight system of claim 5 wherein each current adjustment unit further comprises:
a second diode having an anode coupled to the positive input of the first amplifier and a cathode coupled to the second end of the transistor.

8. The LED backlight system of claim 7 wherein forward conduction voltages of the second diode and the first diode are substantially equal.

9. The LED backlight system of claim 5 wherein each current adjustment unit further comprises:
a zener diode having an anode and a cathode, the anode of the zener diode being coupled to the positive input of the first amplifier; and
a fourth resistor coupled between the cathode of the zener diode and the second end of the transistor for limiting current flowing through the zener diode.

10. A current distributor comprising:
a plurality of current adjustment units for distributing currents flowing through plural sets of LEDs; and
a reference voltage adjustment unit coupled to the plurality of current adjustment units for controlling the plurality of current adjustment units according to a reference voltage, the reference voltage adjustment unit comprising:
a first amplifier having a positive input, a negative input and an output;
a first resistor having a first end for receiving a high voltage and a second end coupled to the negative input of the first amplifier;
a second resistor having a first end for receiving the high voltage and a second end coupled to the positive input of the first amplifier;
a first diode having an anode and a cathode, the anode of the first diode being coupled to the negative input of the first amplifier; and
a reference voltage source having a positive end coupled to the cathode of the first diode and a negative end for receiving a low voltage for providing the reference voltage.

11. The current distributor of claim 10 wherein each current adjustment unit comprises:
a second amplifier having a positive input coupled to the output of the first amplifier, a negative input and an output;
a transistor having a control end coupled to the output of the second amplifier, a first end coupled to the negative input of the second amplifier and a second end coupled to a corresponding set of LEDs; and
a third resistor coupled between the first end of the transistor and the negative end of the reference voltage source.

12. The current distributor of claim 11 wherein the transistor is an N-type MOSFET and operates in saturation region.

13. The current distributor of claim 11 wherein each current adjustment unit further comprises:
a second diode having an anode coupled to the positive input of the first amplifier and a cathode coupled to the second end of the transistor.

14. The current distributor of claim 13 wherein forward conduction voltages of the second diode and the first diode are substantially equal.

15. The current distributor of claim 11 wherein each current adjustment unit further comprises:
a zener diode having an anode and a cathode, the anode of the zener diode being coupled to the positive input of the first amplifier; and
a fourth resistor coupled between the cathode of the zener diode and the second end of the transistor for limiting current flowing through the zener diode.
